(19) United States
(12) Patent Application Publication
(10) Pub. No.: US 2025/0184086 A1
(43) Pub. Date: Jun. 5, 2025

(54) UPLINK CONTROL MULTIPLEXING FOR MULTIPLE TRANSMIT RECEIVE POINTS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/842,081

(22) PCT Filed: Apr. 29, 2022
(86) PCT No.: PCT/CN2022/090152

§ 371 Date: Aug. 28, 2024

(51) Int. Cl. H04L 5/00; H04W 72/21

(52) U.S. Cl. CPC H04L 5/0053; H04L 5/0057; H04W 72/21

(57) ABSTRACT

Various aspects of the present disclosure generally relate to wireless communication. In some aspects, a user equipment (UE) may receive a configuration that specifies that overlapping uplink control informations (UCIs) on one or more physical uplink channels are to be jointly multiplexed into a single UCI for multiple transmit receive points (TRPs) or multiplexed per TRP. The CE may generate the single UCI based at least in part on the configuration by jointly multiplexing the overlapping UCIs into the single UCI without differentiating TRPs or by multiplexing the overlapping UCIs per TRP. The UE may transmit the single UCI in an uplink communication. Numerous other aspects are described.

### FIELD OF THE DISCLOSURE

Aspects of the present disclosure generally relate to wireless communication and to techniques and apparatuses for uplink control information multiplexing for multiple transmit receive points.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration that specifies that overlapping uplink control informations (UCIs) on one or more physical uplink channels are to be jointly multiplexed into a single UCI for multiple transmit receive points (TRPs). The method may include generating the single UCI based at least in part on the configuration by jointly multiplexing the overlapping UCIs into the single UCI without differentiating TRPs. The method may include transmitting the single UCI in an uplink communication.

Some aspects described herein relate to a method of wireless communication performed by a UE. The method may include receiving a configuration that specifies that overlapping UCIs on one or more physical uplink channels for multiple TRPs are to be multiplexed into a single UCI per TRP. The method may include generating, for each TRP based at least in part on the configuration, the single UCI by multiplexing the overlapping UCIs for the TRP into the single UCI. The method may include transmitting the single UCI in an uplink transmission for each TRP.

Some aspects described herein relate to a method of wireless communication performed by a network entity. The method may include transmitting a configuration that specifies that overlapping UCIs on one or more physical uplink channels are to be jointly multiplexed into a single UCI for multiple TRPs. The method may include receiving one or more single UCIs, each single UCI being multiplexed to include overlapping UCIs. The method may include transmitting or receiving a communication based at least in part on the one or more single UCIs.

Some aspects described herein relate to a UE for wireless communication. The UE may include a memory and one or more processors coupled to the memory. The one or more processors may be configured to receive a configuration that specifies that overlapping UCIs on one or more physical uplink channels are to be jointly multiplexed into a single UCI for multiple TRPs. The one or more processors may be configured to generate the single UCI based at least in part on the configuration by jointly multiplexing the overlapping UCIs into the single UCI without differentiating TRPs. The one or more processors may be configured to transmit the single UCI in an uplink communication.

Some aspects described herein relate to a UE for wireless communication. The UE may include a memory and one or more processors coupled to the memory. The one or more processors may be configured to receive a configuration that specifies that overlapping UCIs on one or more physical uplink channels for multiple TRPs are to be multiplexed into a single UCI per TRP. The one or more processors may be configured to generate, for each TRP based at least in part on the configuration, the single UCI by multiplexing the overlapping UCIs for the TRP into the single UCI. The one or more processors may be configured to transmit the single UCI in an uplink transmission for each TRP.

Some aspects described herein relate to a network entity for wireless communication. The network entity may include a memory and one or more processors coupled to the memory. The one or more processors may be configured to transmit a configuration that specifies that overlapping UCIs on one or more physical uplink channels are to be jointly multiplexed into a single UCI for multiple TRPs. The one or more processors may be configured to receive one or more single UCIs, each single UCI being multiplexed to include overlapping UCIs. The one or more processors may be configured to transmit or receive a communication based at least in part on the one or more single UCIs.

Some aspects described herein relate to a non-transitory computer-readable medium that stores a set of instructions for wireless communication by a UE. The set of instructions, when executed by one or more processors of the UE, may cause the UE to receive a configuration that specifies that overlapping UCIs on one or more physical uplink channels are to be jointly multiplexed into a single UCI for multiple TRPs. The set of instructions, when executed by one or more processors of the UE, may cause the UE to generate the single UCI based at least in part on the configuration by jointly multiplexing the overlapping UCIs into the single UCI without differentiating TRPs. The set of instructions, when executed by one or more processors of the UE, may cause the UE to transmit the single UCI in an uplink communication.

Some aspects described herein relate to a non-transitory computer-readable medium that stores a set of instructions for wireless communication by a UE. The set of instructions, when executed by one or more processors of the UE, may cause the UE to receive a configuration that specifies that overlapping UCIs on one or more physical uplink channels for multiple TRPs are to be multiplexed into a single UCI per TRP. The set of instructions, when executed by one or more processors of the UE, may cause the UE to generate, for each TRP based at least in part on the configuration, the single UCI by multiplexing the overlapping UCIs for the TRP into the single UCI. The set of instructions, when executed by one or more processors of the UE, may cause the UE to transmit the single UCI in an uplink transmission for each TRP.

Some aspects described herein relate to a non-transitory computer-readable medium that stores a set of instructions for wireless communication by a network entity. The set of instructions, when executed by one or more processors of the network entity, may cause the network entity to transmit a configuration that specifies that overlapping UCIs on one or more physical uplink channels are to be jointly multiplexed into a single UCI for multiple TRPs. The set of instructions, when executed by one or more processors of the network entity, may cause the network entity to receive one or more single UCIs, each single UCI being multiplexed to include overlapping UCIs. The set of instructions, when executed by one or more processors of the network entity, may cause the network entity to transmit or receive a communication based at least in part on the one or more single UCIs.

Some aspects described herein relate to an apparatus for wireless communication. The apparatus may include means for receiving a configuration that specifies that overlapping UCIs on one or more physical uplink channels are to be jointly multiplexed into a single UCI for multiple TRPs. The apparatus may include means for generating the single UCI based at least in part on the configuration by jointly multiplexing the overlapping UCIs into the single UCI without differentiating TRPs. The apparatus may include means for transmitting the single UCI in an uplink communication.

Some aspects described herein relate to an apparatus for wireless communication. The apparatus may include means for receiving a configuration that specifies that overlapping UCIs on one or more physical uplink channels for multiple TRPs are to be multiplexed into a single UCI per TRP. The apparatus may include means for generating, for each TRP based at least in part on the configuration, the single UCI by multiplexing the overlapping UCIs for the TRP into the single UCI. The apparatus may include means for transmitting the single UCI in an uplink transmission for each TRP.

Some aspects described herein relate to an apparatus for wireless communication. The apparatus may include means for transmitting a configuration that specifies that overlapping UCIs on one or more physical uplink channels are to be jointly multiplexed into a single UCI for multiple TRPs. The apparatus may include means for receiving one or more single UCIs, each single UCI being multiplexed to include overlapping UCIs. The apparatus may include means for transmitting or receiving a communication based at least in part on the one or more single UCIs.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 illustrates an example logical architecture of a distributed radio access network, in accordance with the present disclosure.

FIG. 5 is a diagram illustrating an example of multiple transmit receive point (TRP) communication, in accordance with the present disclosure.

FIG. 6 is a diagram illustrating an example of a slot format, in accordance with the present disclosure.

FIG. 7 is a diagram illustrating an example of using beams for communications between a base station and a UE, in accordance with the present disclosure.

FIG. 8 is a diagram illustrating an example of uplink control information (UCI) multiplexing, in accordance with the present disclosure.

FIG. 9 is a diagram illustrating an example of UCI multiplexing with multiple TRPs, in accordance with the present disclosure.

FIG. 10 is a diagram illustrating an example associated with joint UCI multiplexing for multiple TRPs, in accordance with the present disclosure.

FIG. 11 is a diagram illustrating an example of joint UCI multiplexing, in accordance with the present disclosure.

FIG. 12 is a diagram illustrating an example associated with UCI multiplexing for multiple TRPs per TRP, in accordance with the present disclosure.

FIG. 13 is a diagram illustrating an example of UCI multiplexing for multiple TRPs per TRP, in accordance with the present disclosure.

FIG. 14 is a diagram illustrating an example of UCI multiplexing with multiple TRPs, in accordance with the present disclosure.

FIG. 15 is a diagram illustrating an example process performed, for example, by a UE, in accordance with the present disclosure.

FIG. 16 is a diagram illustrating an example process performed, for example, by a UE, in accordance with the present disclosure.

FIG. 17 is a diagram illustrating an example process performed, for example, by a network entity, in accordance with the present disclosure.

FIGS. 18-19 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

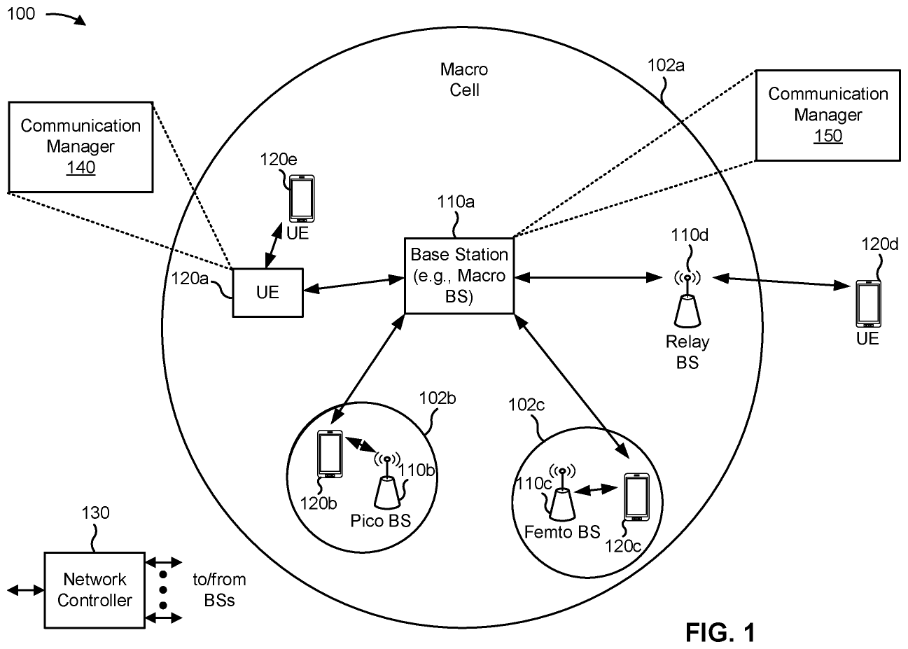

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmit receive point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive a configuration that specifies that overlapping uplink control informations (UCIs) on one or more physical uplink channels are to be jointly multiplexed into a single UCI for multiple TRPs. The communication manager 140 may generate the single UCI based at least in part on the configuration by jointly multiplexing the overlapping UCIs into the single UCI without differentiating TRPs. The communication manager 140 may transmit the single UCI in an uplink communication.

In some aspects, the communication manager 140 may receive a configuration that specifies that overlapping UCIs on one or more physical uplink channels for multiple TRPs are to be multiplexed into a single UCI per TRP. The communication manager 140 may generate, for each TRP based at least in part on the configuration, the single UCI by multiplexing the overlapping UCIs for the TRP into the single UCI. The communication manager may transmit the single UCI in an uplink transmission for each TRP. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit a configuration that specifies that overlapping UCIs on one or more physical uplink channels are to be jointly multiplexed into a single UCI for multiple TRPs. The communication manager 150 may receive one or more single UCIs, each single UCI being multiplexed to include overlapping UCIs. The communication manager 150 may transmit or receive a communication based at least in part on the one or more single UCIs. Additionally, or alternatively, the communication manager 150 may perform one or more other operations described herein.

As indicated above, FIG. 1 is provided as an example. Other examples may differ from what is described with regard to FIG. 1.

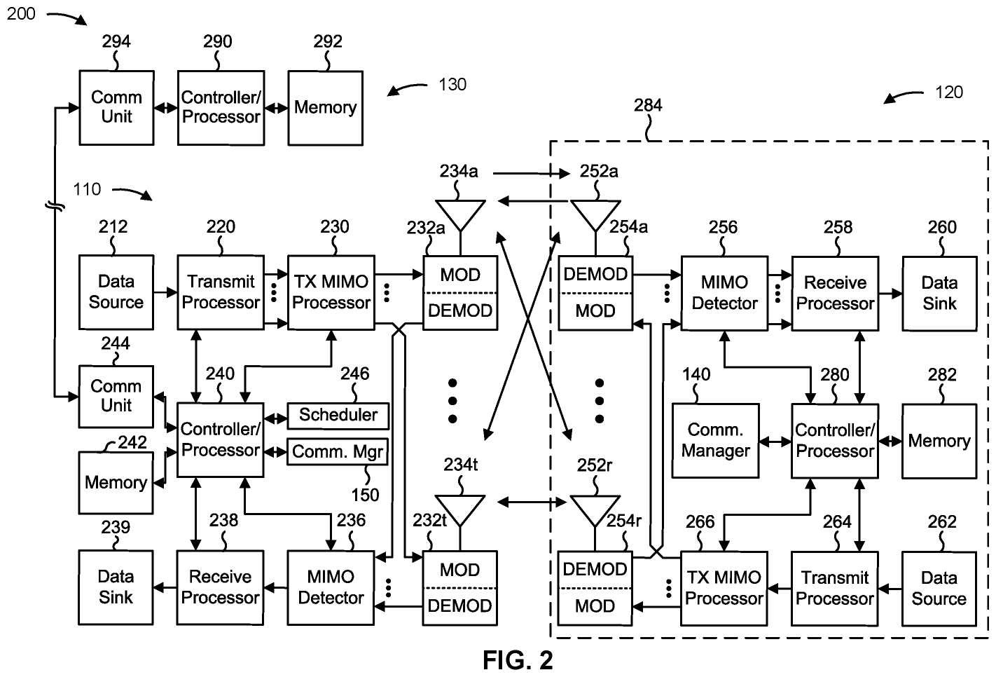

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

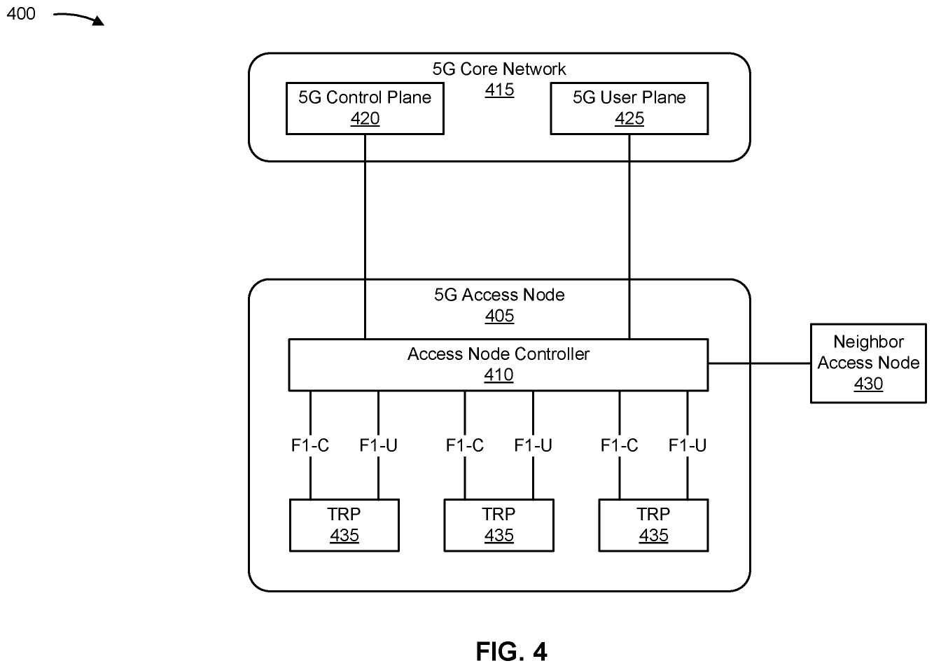

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-19).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-19).

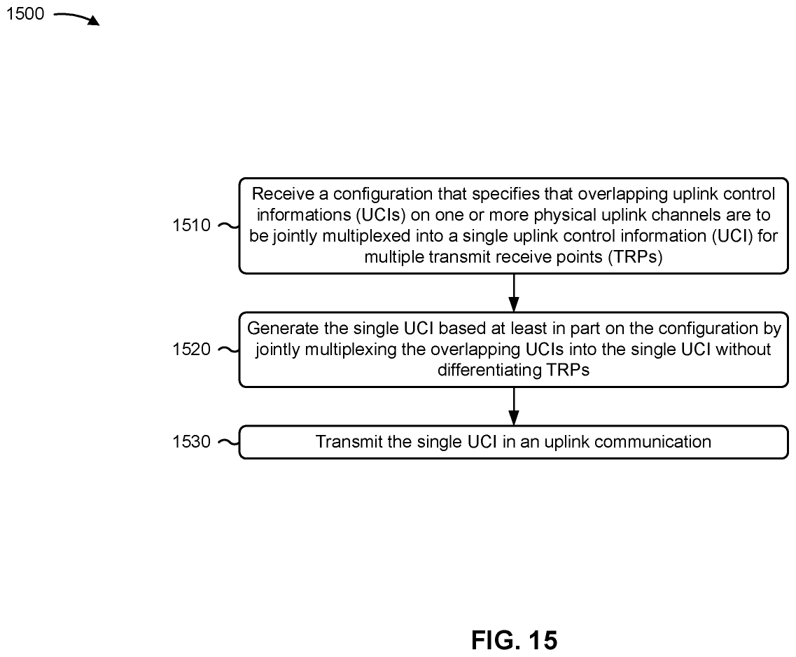

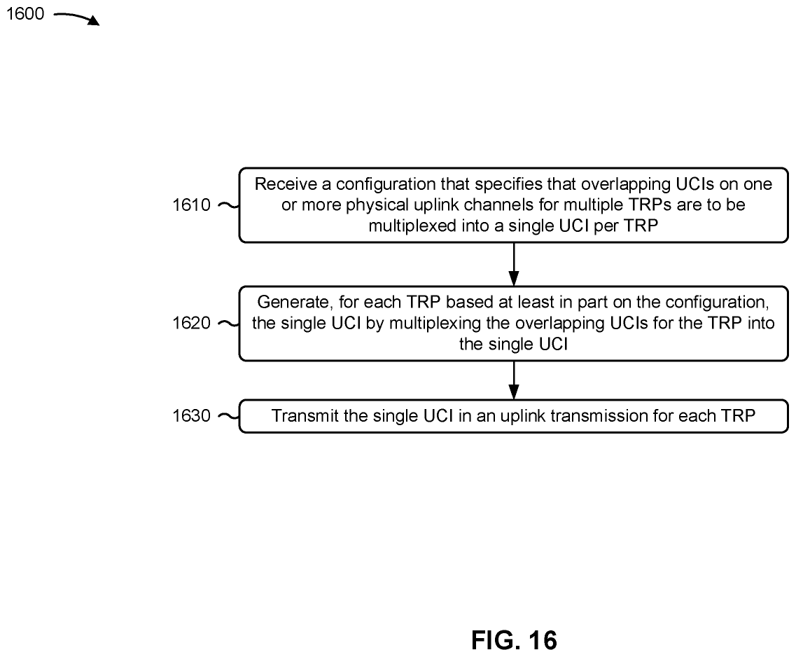

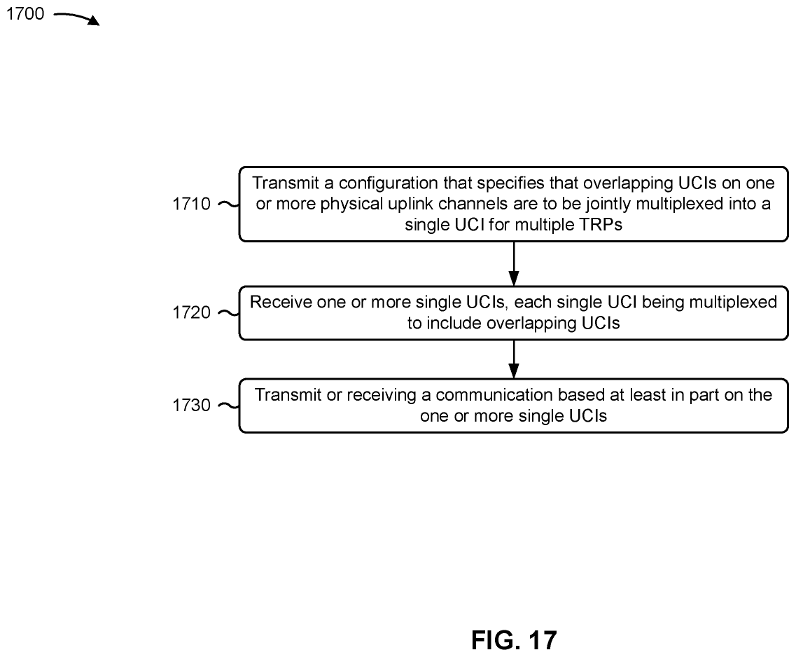

A controller/processor of a network entity, (e.g., the controller/processor 240 of the base station 110), the controller/processor 280 of the UE 120, and/or any other component(s) of FIG. 2 may perform one or more techniques associated with multiplexing UCIs for multiple TRPs, as described in more detail elsewhere herein. For example, the controller/processor 240 of the base station 110, the controller/processor 280 of the UE 120, and/or any other component(s) of FIG. 2 may perform or direct operations of, for example, process 1500 of FIG. 15, process 1600 of FIG. 16, process 1700 of FIG. 17, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1500 of FIG. 15, process 1600 of FIG. 16, process 1700 of FIG. 17, and/or other processes as described herein. In some examples, executing instructions may include running the instructions, converting the instructions, compiling the instructions, and/or interpreting the instructions, among other examples.

In some aspects, the UE 120 includes means for receiving a configuration that specifies that overlapping UCIs on one or more physical uplink channels are to be jointly multiplexed into a single UCI for multiple TRPs; means for generating the single UCI based at least in part on the configuration by jointly multiplexing the overlapping UCIs into the single UCI without differentiating TRPs; and/or means for transmitting the single UCI in an uplink communication. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving a configuration that specifies that overlapping UCIs on one or more physical uplink channels for multiple TRPs are to be multiplexed into a single UCI per TRP; means for generating, for each TRP based at least in part on the configuration, the single UCI by multiplexing the overlapping UCIs for the TRP into the single UCI; and/or means for transmitting the single UCI in an uplink transmission for each TRP.

In some aspects, a network entity (e.g., base station 110) includes means for transmitting a configuration that specifies that overlapping UCIs on one or more physical uplink channels are to be jointly multiplexed into a single UCI for multiple TRPs; means for receiving one or more single UCIs, each single UCI being multiplexed to include overlapping UCIs; and/or means for transmitting or receiving a communication based at least in part on the one or more single UCIs. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

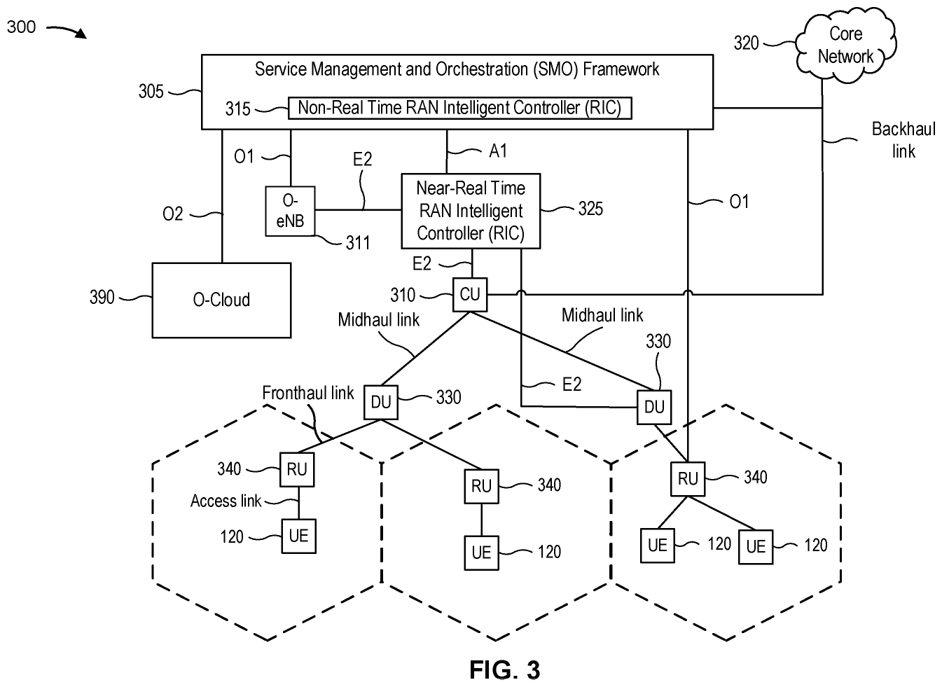

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)).

Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUS (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a network entity, such as base station 110 described above in connection with FIG. 1. For example, different TRPs 435 may be included in different base stations 110. Additionally, or alternatively, multiple TRPs 435 may be included in a single base station 110. In some aspects, a base station 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi-co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

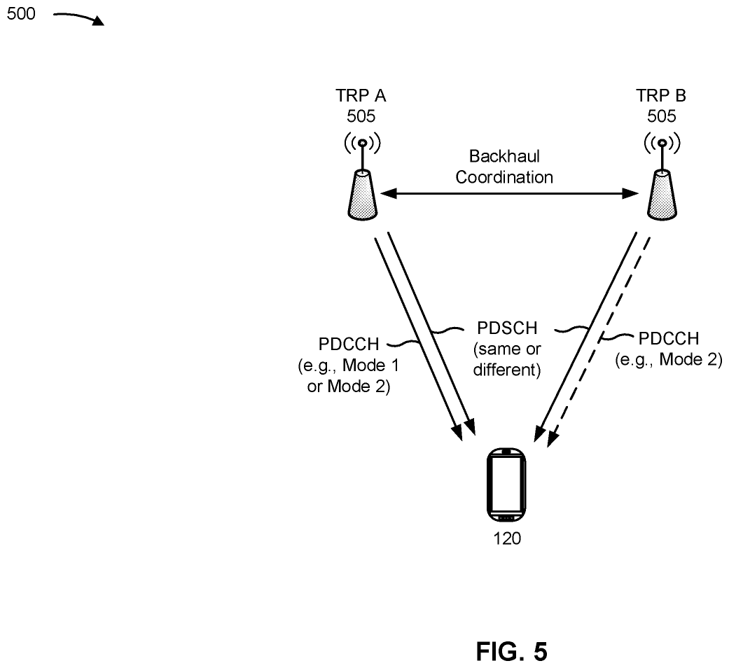

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same base station 110 (e.g., when the TRPs 505 are different antenna arrays or panels of the same base station 110), and may have a larger delay and/or lower capacity (as compared to co-location) when the TRPs 505 are located at different base stations 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

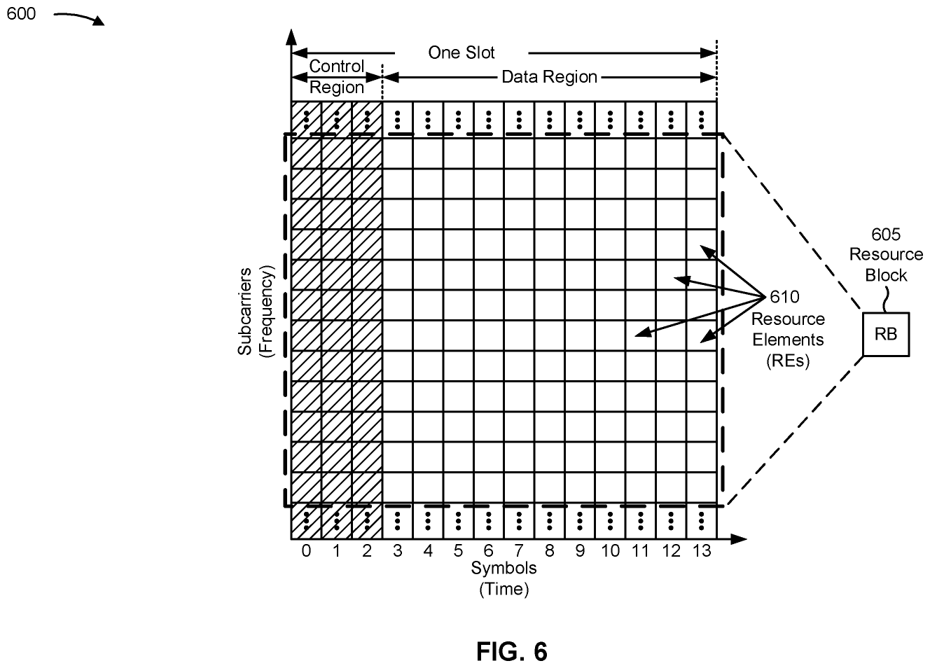

FIG. 6 is a diagram illustrating an example 600 of a slot format, in accordance with the present disclosure. As shown in FIG. 6, time-frequency resources in a radio access network may be partitioned into resource blocks, shown by a single resource block (RB) 605. An RB 605 is sometimes referred to as a physical resource block (PRB). An RB 605 includes a set of subcarriers (e.g., 12 subcarriers) and a set of symbols (e.g., 14 symbols) that are schedulable by a network entity (e.g., base station 110) as a unit. In some aspects, an RB 605 may include a set of subcarriers in a single slot. As shown, a single time-frequency resource included in an RB 605 may be referred to as a resource element (RE) 610. An RE 610 may include a single subcarrier (e.g., in frequency) and a single symbol (e.g., in time). A symbol may be referred to as an OFDM symbol. An RE 610 may be used to transmit one modulated symbol, which may be a real value or a complex value.

In some telecommunication systems (e.g., NR), RBs 605 may span 12 subcarriers with a subcarrier spacing of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., downlink or uplink) for transmission. In some aspects, the link direction for a slot may be dynamically configured.

A downlink channel may include a PDCCH that carries DCI, a PDSCH that carries downlink data, or a physical broadcast channel (PBCH) that carries system information, among other examples. In some aspects, PDSCH communications may be scheduled by PDCCH communications. An uplink channel may include a physical uplink control channel (PUCCH) that carries UCI, a physical uplink shared channel (PUSCH) that carries uplink data, or a PRACH used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As indicated above, FIG. 6 is provided as an example. Other examples may differ from what is described with regard to FIG. 6.

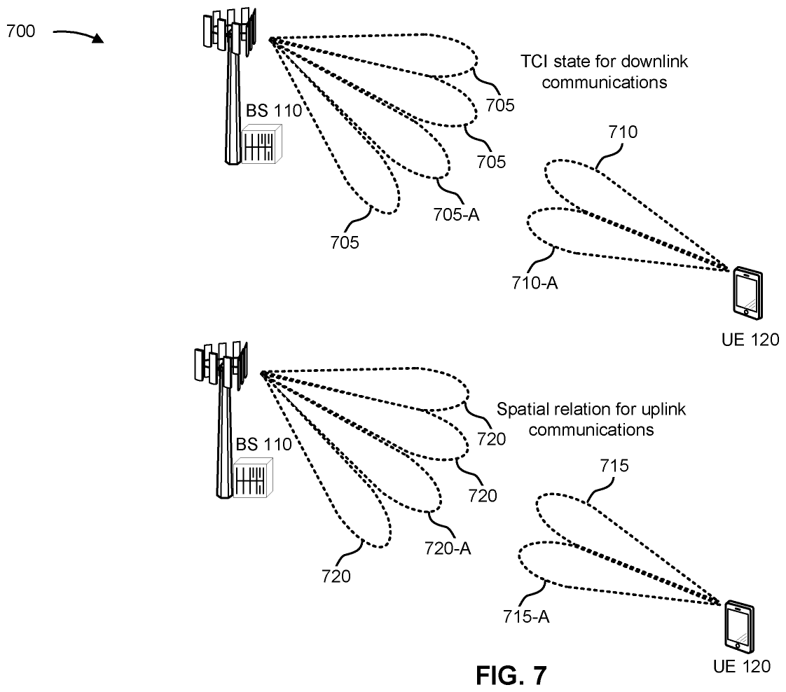

FIG. 7 is a diagram illustrating an example 700 of using beams for communications between a network entity (e.g., base station 110) and a UE, in accordance with the present disclosure. As shown in FIG. 7, a network entity (e.g., a base station 110) and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 705.

The UE 120 may attempt to receive downlink transmissions via one or more UE receive beams 710, which may be configured using different beamforming parameters at receive circuitry of the UE 120. The UE 120 may identify a particular BS transmit beam 705, shown as BS transmit beam 705-A, and a particular UE receive beam 710, shown as UE receive beam 710-A, that provide relatively favorable performance (for example, that have a best channel quality of the different measured combinations of BS transmit beams 705 and UE receive beams 710). In some examples, the UE 120 may transmit an indication of which BS transmit beam 705 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 705-A and the UE receive beam 710-A), which may be further refined and maintained in accordance with one or more established beam refinement procedures.

A downlink beam, such as a BS transmit beam 705 or a UE receive beam 710, may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each BS transmit beam 705 may be associated with a synchronization signal block (SSB), and the UE 120 may indicate a preferred BS transmit beam 705 by transmitting uplink transmissions in resources of the SSB that are associated with the preferred BS transmit beam 705. A particular SSB may have an associated TCI state (for example, for an antenna port or for beamforming). The base station 110 may, in some examples, indicate a downlink BS transmit beam 705 based at least in part on antenna port QCL properties that may be indicated by the TCI state. A TCI state may be associated with one downlink reference signal set (for example, an SSB and an aperiodic, periodic, or semi-persistent channel state information (CSI) reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 710 at the UE 120. Thus, the UE 120 may select a corresponding UE receive beam 710 from a set of BPLs based at least in part on the base station 110 indicating a BS transmit beam 705 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a PDSCH. The set of activated TCI states for downlink control channel communications may correspond to beams that the base station 110 may use for downlink transmission on a PDCCH or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 715.

The base station 110 may receive uplink transmissions via one or more BS receive beams 720. The base station 110 may identify a particular UE transmit beam 715, shown as UE transmit beam 715-A, and a particular BS receive beam 720, shown as BS receive beam 720-A, that provide relatively favorable performance (for example, that have a best channel quality of the different measured combinations of UE transmit beams 715 and BS receive beams 720). In some examples, the base station 110 may transmit an indication of which UE transmit beam 715 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 715-A and the BS receive beam 720-A), which may be further refined and maintained in accordance with one or more established beam refinement procedures. An uplink beam, such as a UE transmit beam 715 or a BS receive beam 720, may be associated with a spatial relation. A spatial relation may indicate a directionality or a characteristic of the uplink beam, similar to one or more QCL properties, as described above.

3GPP standards Release 17 established a unified TCI state framework in which a TCI state may be used to indicate more than one beam. The TCI state may be used to indicate beams for a downlink channel or RS (such as PDCCH/PDSCH/CSI-RS) and/or an uplink channel or RS (such as PUCCH/PUSCH/sounding reference signal (SRS)). There may be multiple types of unified TCI states. For example, a joint downlink/uplink common TCI state (joint TCI) may indicate a common beam for at least one downlink channel or RS and at least one uplink channel or RS. A separate downlink common TCI state (downlink TCI) may indicate a common beam for more than one downlink channel or RS. A separate uplink common TCI state (uplink TCI) may indicate a common beam for more than one uplink channel or RS. Other types of unified TCI states may include a separate downlink single channel or RS TCI state that indicates a beam for a single downlink channel or RS, a separate uplink single channel or RS TCI state that indicates a beam for a single uplink channel or RS, or an uplink spatial relation information, such as a spatial relation indicator (SRI), that indicates a beam for a single uplink channel or RS. In some aspects, uplink MIMO with multiple TRPs may involve TCI states for transmitting multiple layers using time division multiplexing, frequency division multiplexing, or spatial division multiplexing.

As indicated above, FIG. 7 is provided as an example. Other examples may differ from what is described with regard to FIG. 7.

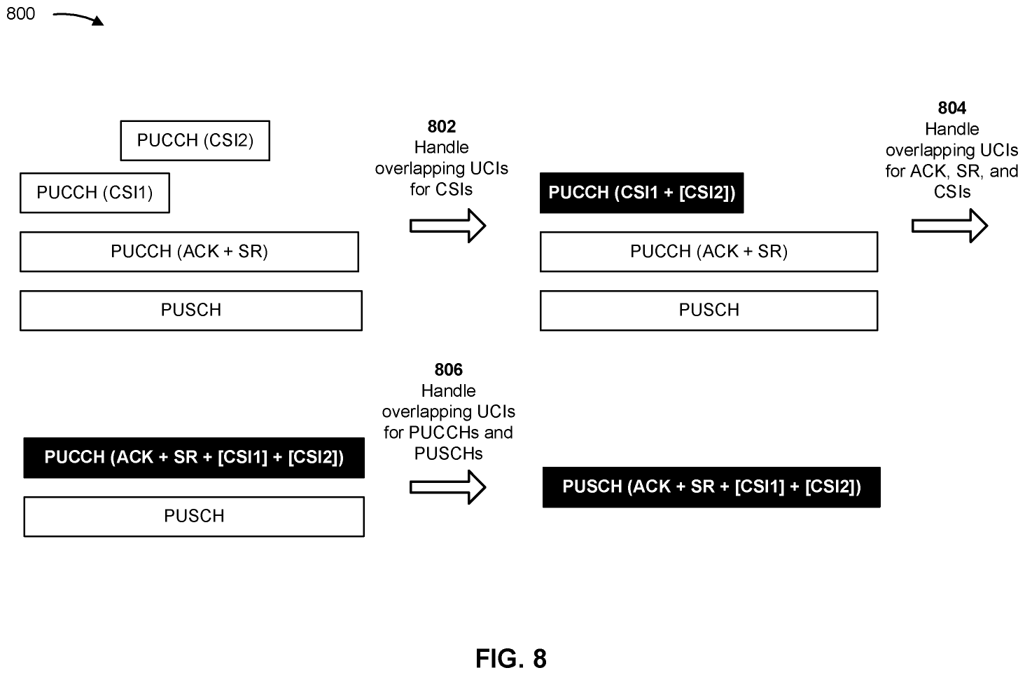

FIG. 8 is a diagram illustrating an example 800 of UCI multiplexing, in accordance with the present disclosure.

Example 800 shows multiple UCIs, including a first CSI report (CSI1) in a first PUCCH communication, a second CSI report (CSI2) in a second PUCCH communication, and feedback (e.g., ACK/NACK bits for PDSCH communications of different hybrid automatic repeat request (HARQ) identifiers (IDs)) and a scheduling request (SR) in a third PUCCH communication. The multiple PUCCH communications used to transmit UCIs overlap with each other and also overlap with a PUSCH communication. The multiple communications used to transmit UCIs may overlap if at least a portion of the UCIs overlap in time or share time resources. For example, the duration of the multiple communications (PUCCH and/or PUSCH) used to transmit the UCIs may overlap with at least one OFDM symbol. “Overlapping UCIs” may be a term that refers to communications that are used to transmit UCIs and that overlap.

A UE may use UCI multiplexing for communications involving a single TRP. The UE may determine a set of overlapping communications of PUCCHs and/or PUSCHs with UCIs in different serving cells configured to the UE. In a first step of UCI multiplexing shown by reference number 802, overlapping UCIs with CSI reports on different PUCCHs, if there are any, may be multiplexed to form a single UCI that is a PUCCH communication with the CSI1 and CSI2, when multiplexing different CSI reports is allowed. Some UCIs may be dropped during UCI multiplexing based on a UCI multiplexing rule. For example, CSI2 may be dropped if necessary. The UE may, in the first step, determine a single PUCCH communication to transmit the UCI of the CSI reports from the set of overlapping communications of PUCCHs with CSI reports.

In a second step of UCI multiplexing shown by reference number 804, overlapping UCIs for feedback, SRs (if there are any), and CSI reports from the first step may be multiplexed to form a single UCI that is a PUCCH communication. In example 800, the PUCCH communication includes an ACK, an SR, CSI1, and CSI2. CSI1 and CSI2 may be dropped, if necessary, and this is indicated by the brackets around CSI1 and CSI2. The UE may, in the second step, determine a single PUCCH communication to transmit the UCI of feedback, SR, and CSI reports from the set of overlapping communications of PUCCHs with feedback, SR, and CSI reports.

In a third step of UCI multiplexing shown by reference number 806, overlapping UCIs for PUCCH communications from the second step and PUSCH communications, if there are any, are multiplexed to form a single PUSCH communication that includes the UCIs. The UCI of an SR may be dropped when the UCI is transmitted in the PUSCH communication.

As indicated above, FIG. 8 is provided as an example. Other examples may differ from what is described with regard to FIG. 8.

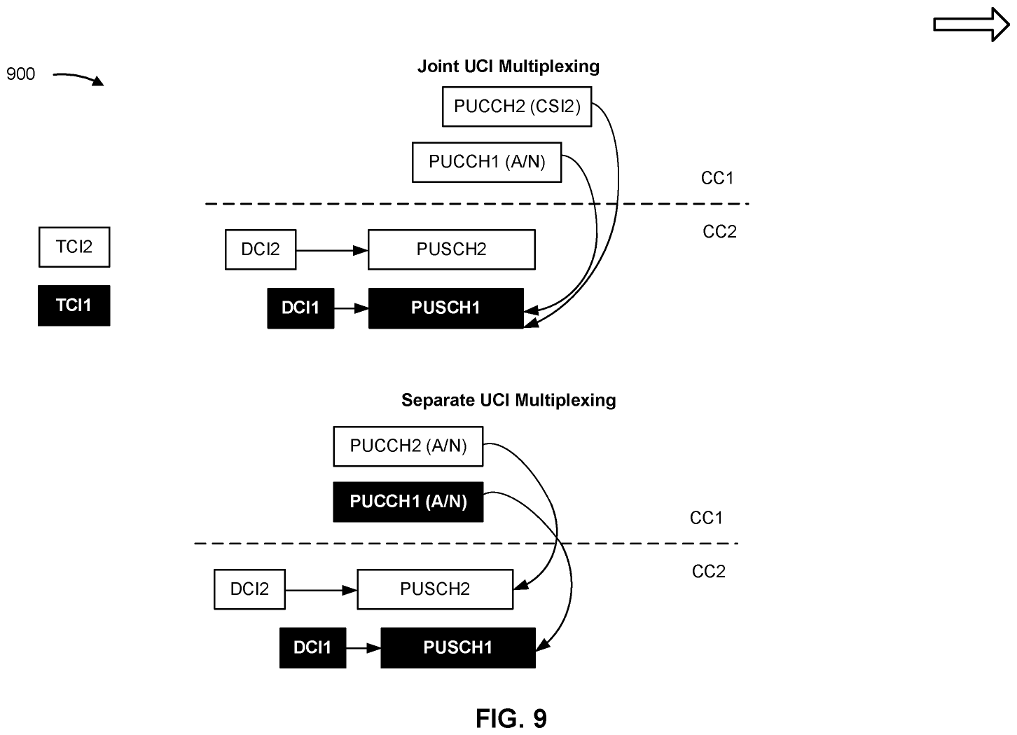

FIG. 9 is a diagram illustrating an example 900 of UCI multiplexing with multiple TRPs, in accordance with the present disclosure.

While example 800 of FIG. 8 shows multiplexing with a single TRP, a UE may operate with multiple TRPs. Different TRPs may be associated with different IDs, such as a CORESET pool index, a TCI state ID, a TCI group ID, a closed loop index, a sounding reference signal (SRS) resource set ID, or a CSI resource set ID. Different UCIs may be associated with different TRPs, based on a predetermined rule. For example, some CSI reports may be associated with a first TRP, and some CSI reports may be associated with a second TRP, and the association between a TRP and a CSI report may be predetermined or preconfigured.

Feedback (e.g., ACK/NACK, or A/N) and SRs may also be associated with different TRPs. For example, feedback bits corresponding to PDSCH communications scheduled in a CORESET of the CORESET pool index 0 or of no CORESET pool index may be associated with the first TRP, and feedback bits corresponding to PDSCH communications scheduled in a CORESET of the CORESET pool index 1 may be associated with the second TRP. Different PUCCH or PUSCH communications may also be associated with different TRPs, based on a predetermined rule. It has not been specified how the UE is to handle UCI multiplexing with multiple TRPs. Without an appropriate configuration for UCI multiplexing with multiple TRPs, the UE may consume additional processing resources and signaling resources due to inefficiencies in transmitting UCIs for multiple TRPs.

According to various aspects described herein, a network entity may configure a UE with a configuration that specifies that overlapping UCIs on physical uplink channels (e.g., PUSCH, PUCCH) are to be multiplexed into a single UCI for multiple TRPs. The UE may multiplex the overlapping UCIs into a single UCI according to the configuration. The UE may transmit the single UCI to the network entity, and the network entity may determine precoding information or other information for future communications based at least in part on the UCIs in the single UCI.

In some aspects, the configuration may specify joint UCI multiplexing. The joint UCI multiplexing may enable the UE to multiplex UCIs in different PUCCH communications and/or different PUSCH communications associated with different TRPs into a single UCI to be transmitted in an uplink communication, which may be either a PUCCH communication or a PUSCH communication based at least in part on a UCI multiplexing rule. The UE may jointly multiplex overlapping UCIs into a single UCI without differentiating TRPs. That is, the UE may multiplex UCIs independent of or without regard to which TRP a UCI is associated or to which TRP a PUCCH/PUSCH communication is associated. The UE may follow a single TRP rule, as shown in FIG. 8, to multiplex overlapping UCIs from multiple TRPs as if the overlapping UCIs for different TRPs were all for a single TRP. For example, when the UE is configured with multiple DCI based multiple TRP operation and is configured with a parameter such as “joint UCI transmission”, the UE may multiplex all UCIs, if not dropped, from different overlapping PUCCH communications and/or PUSCH communications into a single PUCCH communication or single PUSCH communication.

Example 900 shows communications associated with two TCI states (TCI1 and TCI2), each TCI state directing uplink communications to a TRP. TCI1 is for a first TRP and is shown by black boxes. TCI2 is for a second TRP and is shown by white boxes. Although PUCCH communications PUCCH1 and PUCCH2 are associated with TCI2 (second TRP), the UCIs on PUCCH1 and PUCCH2 may be multiplexed into a PUSCH communication (PUSCH1) associated with TCI1 (first TRP). That is, joint UCI multiplexing is not restricted to the same TRP. In some aspects, the UE may select one or more UCIs for UCI multiplexing if two PUSCH communications have the same starting symbols and/or are associated with a specified CORESET (e.g., CORESET pool index 0). For example, when the UE is to multiplex all UCIs from different overlapping PUCCH communications into one of the multiple PUSCH communications in a serving cell which are of the same grant type (all dynamically granted PUSCHs or all configured granted PUSCHs) and of the same starting symbols, the UE may select one PUSCH communication among the multiple PUSCH communications to transmit all of the UCIs. The selected PUSCH communication may be associated with a specific TRP. For example, the selected PUSCH communication may be associated with a lower CORESET pool index, a lower TCI ID, or a lower SRS resource set ID.

Alternatively, in some aspects, the configuration may specify separate UCI multiplexing, where overlapping UCIs are multiplexed into a single UCI per TRP. There may be a single UCI for each TRP and thus there can be multiple single UCIs for multiple TRPs.

Example 900 shows separate UCI multiplexing. UCIs on PUCCH2 are associated with TCI2 (second TRP) and multiplexed into PUSCH2 (also associated with TCI2) but not multiplexed into PUSCH1 (associated with TCI1). PUCCH1 is multiplexed into PUSCH1, as both are associated with TCI1. That is, the UCI multiplexing shown in FIG. 8 is applied within each TRP and not across multiple TRPs. A configuration may also include timing conditions for determining which UCIs are overlapping and/or for determining which overlapping UCIs may be multiplexed.

In some aspects, when the UE is configured with multiple based multiple TRP operation and is configured with a parameter “separate UCI transmission”, the UE multiplexes all UCIs on different overlapping PUCCH communications and/or PUSCH communications associated with a TRP into a single PUCCH communication or a single PUSCH communication associated with the same TRP, based on the UCI multiplexing rules and procedures. Firstly, the UE may determine a set of overlapping PUCCH communications and/or PUSCH communications for each TRP. For example, the UE may determine a set of overlapping PUCCH communications and/or PUSCH communications are associated with the same TRP if the set of overlapping PUCCH and/or PUSCHs associated with the same CORESET pool index or sharing the same TCI ID.

Secondly, for each TRP, the UE may individually apply UCI multiplying rules and procedures among the set of overlapping PUCCH communications and/or PUSCH communications determined for the TRP. For example, the UCI multiplying rules and procedures for each TRP may be performed as shown in FIG. 8. In the end, the UE may determine a single PUCCH communication or a single PUSCH communication for a TRP to transmit all of the UCIs, if not dropped, on different overlapping PUCCH communications or PUSCH communications associated with the TRP.

When applying UCI multiplexing rules and procedures for each TRP, the UE may also apply the individual timing requirement for different TPRs to determine whether a UCI should be multiplexed or dropped. In some aspects, the UE may determine the uplink communications to multiplex with UCIs for different TRPs are of same type. The UE may not expect the determined uplink communications to multiplex with UCIs for different TRPs are of different types. For example, the UE may not expect the determined uplink communications to multiplex with UCIs for a TRP is a PUCCH communication and the determined uplink communications to multiplex with UCIs for another TRP is a PUSCH communication.

By using a configuration that specifies UCI multiplexing for multiple TRPs, the network entity and the UE may have more certainty in transmitting UCIs and may conserve processing resources and signaling resources.

As indicated above, FIG. 9 is provided as an example. Other examples may differ from what is described with regard to FIG. 9.

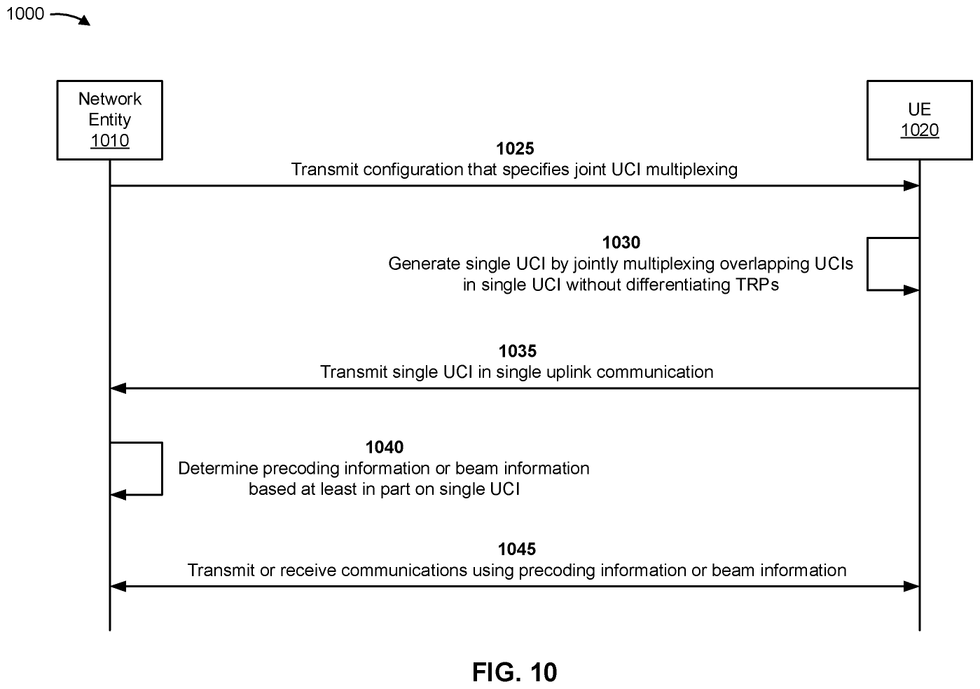

FIG. 10 is a diagram illustrating an example 1000 associated with joint UCI multiplexing for multiple TRPs, in accordance with the present disclosure. As shown in FIG. 10, a network entity 1010 (e.g., base station 110) and a UE 1020 (e.g., a UE 120) may communicate with one another on a wireless network (e.g., wireless network 100).

As shown by reference number 1025, the network entity 1010 may transmit a configuration that specifies joint UCI multiplexing. As shown by reference number 1030, the UE 1020 may generate a single UCI by jointly multiplexing overlapping UCIs into the single UCI without differentiating TRPs. The overlapping UCIs may include feedback (e.g., ACK/NACK), an SR, or a CSI report associated with the multiple TRPs.

The UE 1020 may select resources for a physical uplink channel communication on the one or more physical uplink channels to be resources for the single UCI. The UE 1020 may select resources for physical uplink channel communications of one TRP of the multiple TRPs to be resources for the single UCI. The physical uplink channel communications may be in a same serving cell and have a same starting symbol. In some aspects, the UE 1020 may generate the single UCI by selecting resources for a physical uplink channel of the one or more physical uplink channels to be resources associated with a specified CORESET pool index.

In some aspects, the UE 1020 may puncture resources for a PUSCH communication for the single UCI. Puncturing may include not allocating some resources for data in the PUSCH communication and using those resources for the single UCI. This may be applicable if the UCI bits are 1 or 2 bits, such as 1 or 2 bits for feedback.

In some aspects, the UE 1020 may jointly multiplex overlapping UCIs by jointly multiplexing one or more UCIs on a PUCCH and one or more UCIs on a PUSCH into the single UCI. The UE 1020 may also jointly multiplex the overlapping UCIs by jointly multiplexing one or more UCIs in one or more PUCCH communications and one or more UCIs in one or more second PUCCH communications into the single UCI. In some aspects, the UE 1020 may multiplex aperiodic CSI or semi-persistent (SP) CSI reports on a PUSCH into a PUSCH communication. This may involve CSI-triggering DCI or activating DCI.

As shown by reference number 1035, the UE 1020 may transmit the single UCI in a single uplink communication. The network entity 1010 may demultiplex the single UCI based on the configuration and use the UCIs in the single UCI. As shown by reference number 1040, the network entity 1010 may determine precoding information, beam information, and/or other communication information based at least in part on the UCIs in the single UCI. As shown by reference number 1045, the network entity 1010 may transmit or receive communications using the precoding information, the beam information, and/or the other information. By jointly multiplexing UCIs without differentiating TRPs, the UE 1020 may be more efficient with transmitting UCIs for multiple TRPs and may conserve processing resources and signaling resources.

As indicated above, FIG. 10 is provided as an example. Other examples may differ from what is described with respect to FIG. 10.

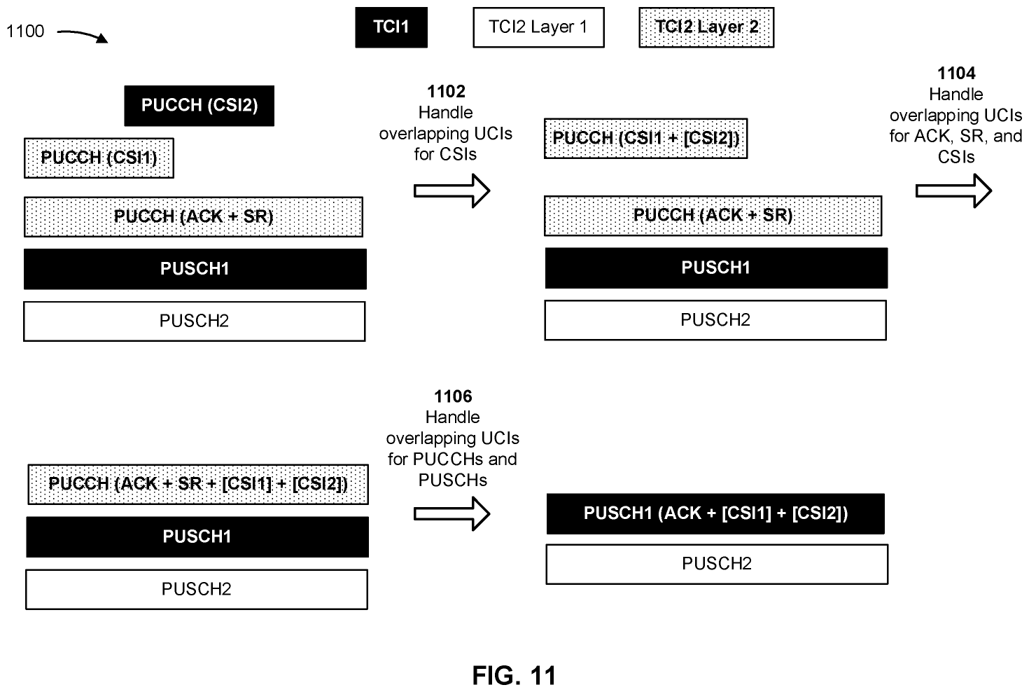

FIG. 11 is a diagram illustrating an example 1100 of joint UCI multiplexing, in accordance with the present disclosure.

Example 1100 shows steps for UCI multiplexing without differentiating TRPs. Boxes are shaded to indicate different TCI states to different TRPs, including different layers of a TCI state. As shown by reference number 1102, the UE 1020 may handle overlapping CSI reports and multiplex CSI1 and CSI2 on different PUCCH communications into a single PUCCH communication (CSI1+[CSI2]). As shown by reference number 1104, the UE 1020 may handle overlapping feedback (e.g., ACK), SRs, and/or CSI reports and multiplex PUCCH (CSI1+[CSI2]) and PUCCH (ACK+SR) into a single PUCCH communication (ACK+SR+[CSI1]+[CSI2]). As shown by reference number 1106, the UE 1020 may handle overlapping the PUCCH communications and the PUSCH communications and may multiplex the multiplexed UCIs on the PUCCH communication into the PUSCH communication. When there are two PUSCH communications (PUSCH1 and PUSCH2), both having the same starting symbols in a serving cell, the UE may select one PUSCH communication based at least in part on a predetermined rule. For example, the PUSCH1 may be associated with a lower CORESET pool index, and the UE may determine to use PUSCH1 for multiplex all of the UCIs.

As indicated above, FIG. 11 is provided as an example. Other examples may differ from what is described with regard to FIG. 11.

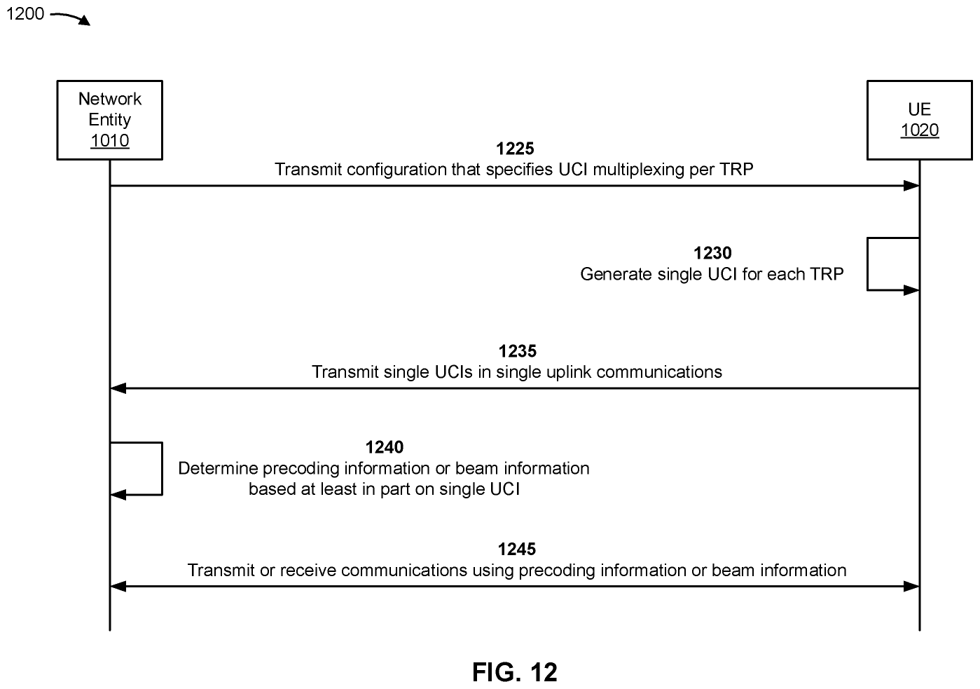

FIG. 12 is a diagram illustrating an example 1200 associated with UCI multiplexing for multiple TRPs per TRP, in accordance with the present disclosure.

As shown by reference number 1225, the network entity 1010 may transmit a configuration that specifies UCI multiplexing per TRP. This includes multiplexing overlapping UCIs into a single UCI that belong to the same TRP. There may be a single UCI for each TRP of multiple TRPs. As shown by reference number 1230, the UE 1020 may generate, for each TRP based at least in part on the configuration, the single UCI by multiplexing the overlapping UCIs for the TRP into the single UCI.

The UE 1020 may select resources for a physical uplink channel communication on the one or more physical uplink channels associated with the TRP to be resources for the single UCI for the TRP. In some aspects, the UE 1020 may puncture resources for a PUSCH communication for the single UCI for each TRP.

In some aspects, the UE 1020 may jointly multiplex periodic or SP CSI reports in PUCCH communications associated with different TRPs into a physical uplink channel communication associated with a specified CORESET pool index (e.g., CORESET pool index 0).

In some aspects, the UE 1020 may multiplex CSI reports in one or more physical uplink channel communications per TRP. The UE 1020 may multiplex feedback and/or SRs in one or more physical uplink channel communications per TRP. The UE 1020 may multiplex one or more UCIs on a PUCCH and one or more UCIs on a PUSCH into the single UCI per TRP. The UE 1020 may determine that the one or more UCIs on the PUCCH and the one or more UCIs on the PUSCH share the same TRP based at least in part on a rule. The rule may be based at least in part on a shared TCI state. That is, the same TCI state may indicate the same TRP. Other rules may be used.

In some aspects, the UE 1020 may multiplex one or more UCIs in one or more first PUCCH communications and one or more UCIs in one or more second PUCCH communications into the single UCI per TRP. The UE 1020 may determine that the one or more UCIs in the one or more first PUCCH communications and the one or more UCIs in the one or more second PUCCH communications share the same TRP based at least in part on a rule.

As shown by reference number 1235, the UE 1020 may transmit single UCIs, where each single UCI is for a TRP. The UE 1020 may transmit each single UCI in a single uplink communication. The network entity 1010 may demultiplex the single UCI based on the configuration and use the UCIs in the single UCI. As shown by reference number 1240, the network entity 1010 may determine precoding information, beam information, and/or other communication information based at least in part on the UCIs in the single UCI. As shown by reference number 1245, the network entity 1010 may transmit or receive communications using the precoding information, the beam information, and/or the other information. By multiplexing UCIs per TRP, the UE 1020 may provide the network entity 1010 TRP-specific UCIs. The UE 1020 may be more efficient with transmitting UCIs for multiple TRPs and may conserve processing resources and signaling resources.

As indicated above, FIG. 12 is provided as an example. Other examples may differ from what is described with respect to FIG. 12.

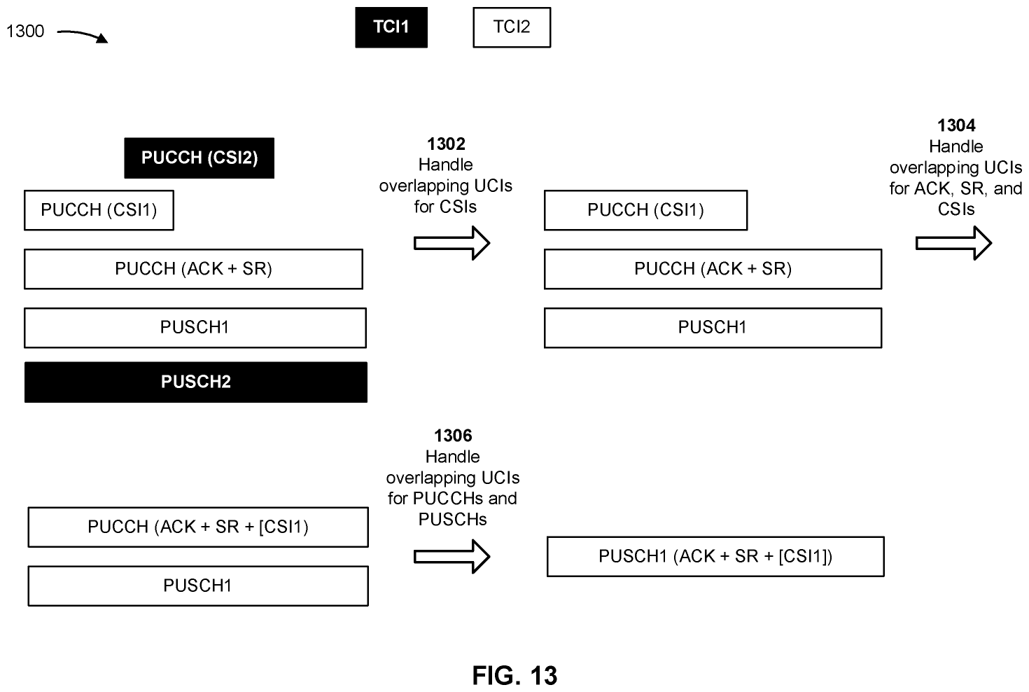

FIG. 13 is a diagram illustrating an example 1300 of UCI multiplexing for multiple TRPs per TRP, in accordance with the present disclosure.

Example 1300 shows steps for UCI multiplexing per TRP. Black and white boxes indicate different TCI states to different TRPs. For example, PUCCH (CSI2) and PUSCH2 are associated with TCI state 1 for a first TRP (black boxes for TCI1), while other UCIs are associated with TCI state 2 for a second TRP (white boxes for TCI2). The UE 1020 is to multiplex overlapping UCIs for a single TRP. In example 1300, the UE 1020 is to multiplex overlapping UCIs associated with the uplink communications applied with the TCI2.

As shown by reference number 1302, the UE 1020 may handle overlapping CSI reports. As only PUCCH (CSI1) is associated with TCI2, UE 1020 does not multiplex PUCCH (CSI1) and PUCCH (CSI2). As shown by reference number 1304, the UE 1020 may handle overlapping feedback (e.g., ACK), SRs, and/or CSI reports and multiplex PUCCH (CSI1) and PUCCH (ACK+SR) into a PUCCH (ACK+SR+[CSI1]). As shown by reference number 1306, the UE 1020 may handle overlapping PUCCH communications and PUSCH communications and may multiplex the PUCCH communication into PUSCH1 (ACK+SR+[CSI1]). PUSCH2 is ignored because PUSCH2 is associated with TCI1. The PUSCH1 for TCI2 (second TRP) may be included in a single UCI in a single uplink communication.

The UE 1020 may proceed with multiplexing overlapping UCIs for another TRP. For example, the UE 1020 may multiplex PUCCH (CSI2) into PUSCH2 to form PUSCH2 (CSI2). The PUSCH2 may be included in another single UCI in another single uplink communication. In some aspects, CSI reports from multiple TRPs may be multiplexed at step 1302 without differentiating TRPs, but steps 1304 and 1306 may remain per TRP.

As indicated above, FIG. 13 is provided as an example. Other examples may differ from what is described with regard to FIG. 13.

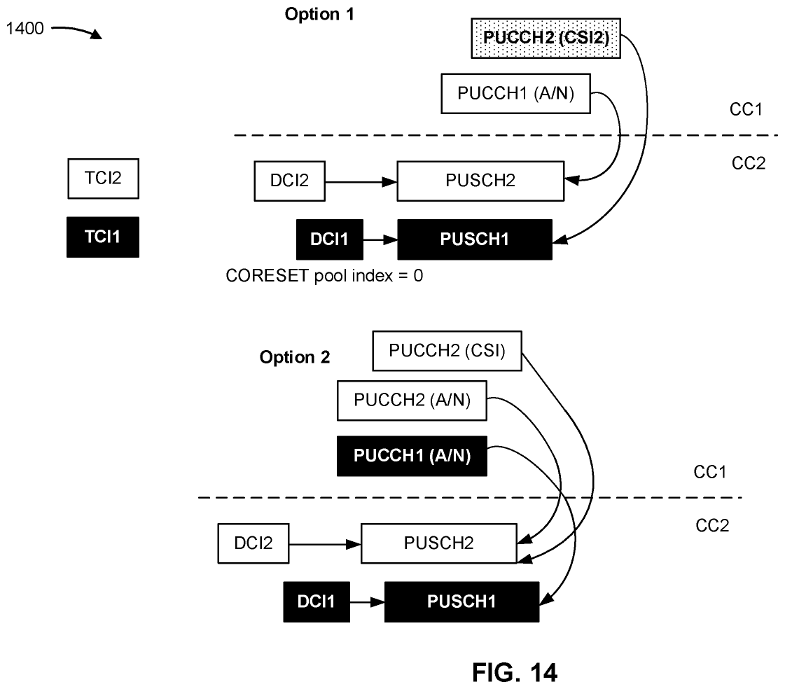

FIG. 14 is a diagram illustrating an example 900 of UCI multiplexing with multiple TRPs, in accordance with the present disclosure.

Example 1400 shows multiplexing of periodic or SP CSI reports on a PUCCH. In some aspects, the UE 1020 may handle periodic or SP CSI reports on a PUCCH. The UE 1020 may multiplex periodic or SP CSI reports on PUCCHs into an overlapping PUSCH communication.

In some aspects, as a first option (Option 1), the PUSCH communication may be associated with a specified CORESET pool index (e.g., CORESET pool index 0), if any CORESETs are applicable. The black box DCI may be associated with CORESET pool index 0. Example 1400 shows PUCCH1 and PUCCH2 multiplexed into PUSCH1. Otherwise, the UE 1020 may multiplex the periodic or SP CSI reports into another PUSCH communication.

Alternatively, in some aspects, as a second option (Option 2), the UE 1020 may multiplex periodic or SP CSI reports on a PUCCH into an overlapping PUSCH communication associated with the same TRP. Example 1400 shows multiplexing PUCCH2 (CSI) and PUCCH2 (A/N) into PUSCH2, all of which are associated with TCI2, or the second TRP. Example 1400 also shows multiplexing PUCCH1 into PUSCH1, all of which are associated with TCI1, or the first TRP. Either option is configurable by the network entity 1010 for joint UCI multiplexing or for UCI multiplexing per TRP.

As indicated above, FIG. 14 is provided as an example. Other examples may differ from what is described with regard to FIG. 14.

FIG. 15 is a diagram illustrating an example process 1500 performed, for example, by a UE, in accordance with the present disclosure. Example process 1500 is an example where the UE (e.g., UE 120, UE 1020) performs operations associated with UCI multiplexing for multiple TRPs without differentiating TRPs.

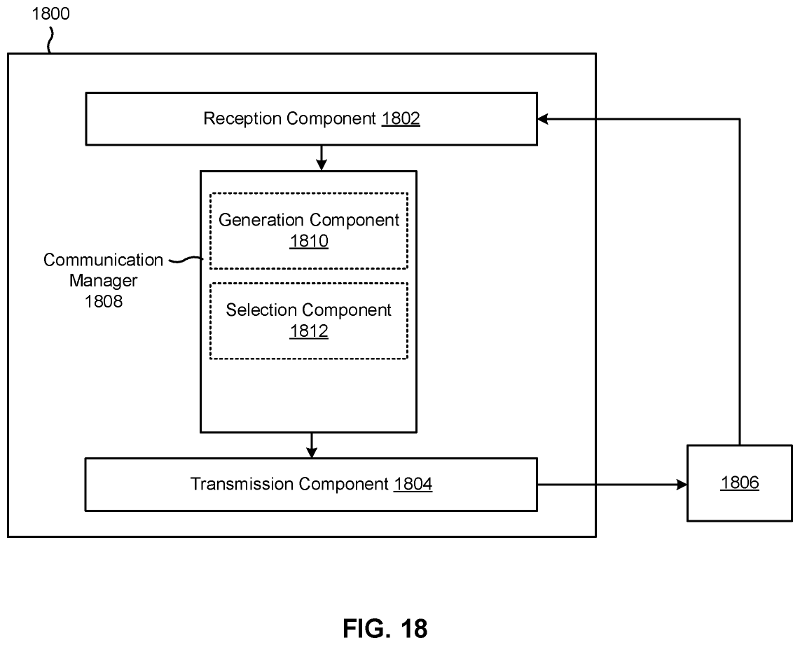

As shown in FIG. 15, in some aspects, process 1500 may include receiving a configuration that specifies that overlapping UCIs on one or more physical uplink channels are to be jointly multiplexed into a single UCI for multiple TRPs (block 1510). For example, the UE (e.g., using communication manager 1808 and/or reception component 1802 depicted in FIG. 18) may receive a configuration that specifies that overlapping UCIs on one or more physical uplink channels are to be jointly multiplexed into a single UCI for multiple TRPs, as described above.

As further shown in FIG. 15, in some aspects, process 1500 may include generating the single UCI based at least in part on the configuration by jointly multiplexing the overlapping UCIs into the single UCI without differentiating TRPs (block 1520). For example, the UE (e.g., using communication manager 1808 and/or generation component 1810 depicted in FIG. 18) may generate the single UCI based at least in part on the configuration by jointly multiplexing the overlapping UCIs into the single UCI without differentiating TRPs, as described above.

As further shown in FIG. 15, in some aspects, process 1500 may include transmitting the single UCI in an uplink communication (block 1530). For example, the UE (e.g., using communication manager 1808 and/or transmission component 1804 depicted in FIG. 15) may transmit the single UCI in an uplink communication, as described above.

Process 1500 may include additional aspects, such as any single aspect or any combination of aspects described below and/or in connection with one or more other processes described elsewhere herein.

In a first aspect, generating the single UCI includes selecting resources for a physical uplink channel communication on the one or more physical uplink channels to be resources for the single UCI.

In a second aspect, alone or in combination with the first aspect, process 1500 includes puncturing resources for a PUSCH communication for the single UCI.

In a third aspect, alone or in combination with one or more of the first and second aspects, the overlapping UCIs include one or more of feedback, a scheduling request, or a CSI report associated with the multiple TRPs.

In a fourth aspect, alone or in combination with one or more of the first through third aspects, process 1500 includes selecting resources for physical uplink channel communications of one TRP of the multiple TRPs to be resources for the single UCI.

In a fifth aspect, alone or in combination with one or more of the first through fourth aspects, the physical uplink channel communications are in a same serving cell and have a same starting symbol.

In a sixth aspect, alone or in combination with one or more of the first through fifth aspects, generating the single UCI includes selecting resources for a physical uplink channel of the one or more physical uplink channels to be resources associated with a specified CORESET pool index.

In a seventh aspect, alone or in combination with one or more of the first through sixth aspects, jointly multiplexing the overlapping UCIs includes jointly multiplexing one or more UCIs on a PUCCH and one or more UCIs on a PUSCH into the single UCI.

In an eighth aspect, alone or in combination with one or more of the first through seventh aspects, jointly multiplexing the overlapping UCIs includes jointly multiplexing one or more UCIs in one or more first PUCCH communications and one or more UCIs in one or more second PUCCH communications into the single UCI.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, by a UE, in accordance with the present disclosure. Example process 1600 is an example where the UE (e.g., UE 120, UE 1020) performs operations associated with UCI multiplexing for multiple TRPs per TRP.

As shown in FIG. 16, in some aspects, process 1600 may include receiving a configuration that specifies that overlapping UCIs on one or more physical uplink channels for multiple TRPs are to be multiplexed into a single UCI per TRP (block 1610). For example, the UE (e.g., using communication manager 1808 and/or reception component 1802 depicted in FIG. 18) may receive a configuration that specifies that overlapping UCIs on one or more physical uplink channels for multiple TRPs are to be multiplexed into a single UCI per TRP, as described above.

As further shown in FIG. 16, in some aspects, process 1600 may include generating, for each TRP based at least in part on the configuration, the single UCI by multiplexing the overlapping UCIs for the TRP into the single UCI (block 1620). For example, the UE (e.g., using communication manager 1808 and/or generation component 1810 depicted in FIG. 10) may generate, for each TRP based at least in part on the configuration, the single UCI by multiplexing the overlapping UCIs for the TRP into the single UCI, as described above.

As further shown in FIG. 16, in some aspects, process 1600 may include transmitting the single UCI in an uplink transmission for each TRP (block 1630). For example, the UE (e.g., using communication manager 1808 and/or transmission component 1804 depicted in FIG. 18) may transmit the single UCI in an uplink transmission for each TRP, as described above.

Process 1600 may include additional aspects, such as any single aspect or any combination of aspects described below and/or in connection with one or more other processes described elsewhere herein.

In a first aspect, generating the single UCI for a TRP includes selecting resources for a physical uplink channel communication on the one or more physical uplink channels associated with the TRP to be resources for the single UCI for the TRP.

In a second aspect, alone or in combination with the first aspect, process 1600 includes puncturing resources for a PUSCH communication for the single UCI for each TRP.

In a third aspect, alone or in combination with one or more of the first and second aspects, the multiplexing includes jointly multiplexing periodic CSI reports or SP CSI reports in PUCCH communications associated with different TRPs into a physical uplink channel communication associated with a specified CORESET pool index.

In a fourth aspect, alone or in combination with one or more of the first through third aspects, the multiplexing includes multiplexing CSI reports in one or more physical uplink channel communications per TRP.

In a fifth aspect, alone or in combination with one or more of the first through fourth aspects, the multiplexing includes multiplexing feedback or SRs in one or more physical uplink channel communications per TRP.

In a sixth aspect, alone or in combination with one or more of the first through fifth aspects, the multiplexing includes multiplexing one or more UCIs on a PUCCH and one or more UCIs on a PUSCH into the single UCI per TRP.

In a seventh aspect, alone or in combination with one or more of the first through sixth aspects, process 1600 includes determining that the one or more UCIs on the PUCCH and the one or more UCIs on the PUSCH share a same TRP based at least in part on a rule.

In an eighth aspect, alone or in combination with one or more of the first through seventh aspects, the rule is based at least in part on a shared TCI state.

In a ninth aspect, alone or in combination with one or more of the first through eighth aspects, the multiplexing includes multiplexing one or more UCIs in one or more first PUCCH communications and one or more UCIs in one or more second PUCCH communications into the single UCI per TRP.

In a tenth aspect, alone or in combination with one or more of the first through ninth aspects, process 1600 includes determining that the one or more UCIs in the one or more first PUCCH communications and the one or more UCIs in the one or more second PUCCH communications share a same TRP based at least in part on a rule.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a network entity, in accordance with the present disclosure. Example process 1700 is an example where the network entity (e.g., base station 110, network entity 1010) performs operations associated with configuring a UE for UCI multiplexing for multiple TRPs.

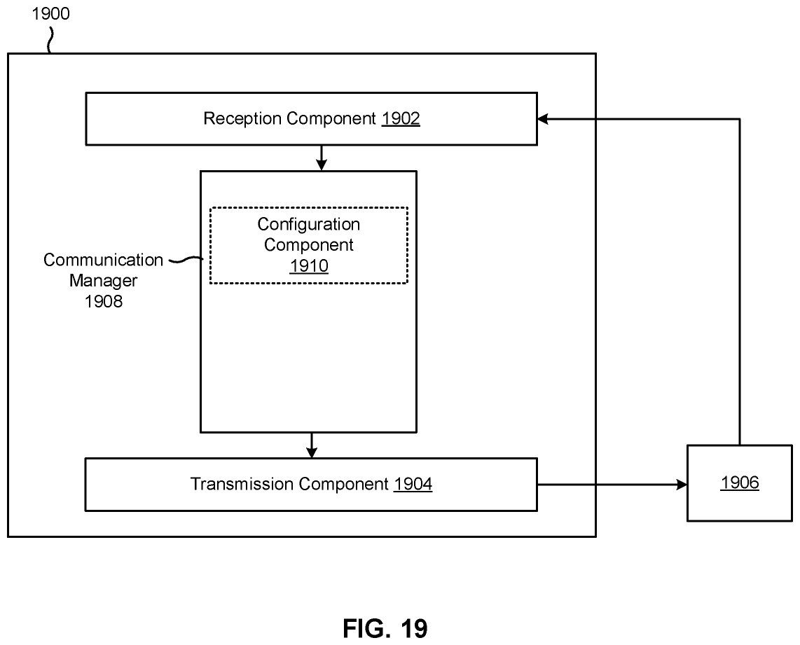

As shown in FIG. 17, in some aspects, process 1700 may include transmitting a configuration that specifies that overlapping UCIs on one or more physical uplink channels are to be jointly multiplexed into a single UCI for multiple TRPs (block 1710). For example, the network entity (e.g., using communication manager 1908 and/or transmission component 1904 depicted in FIG. 19) may transmit a configuration that specifies that overlapping UCIs on one or more physical uplink channels are to be jointly multiplexed into a single UCI for multiple TRPs, as described above.

As further shown in FIG. 17, in some aspects, process 1700 may include receiving one or more single UCIs, each single UCI being multiplexed to include overlapping UCIs (block 1720). For example, the network entity (e.g., using communication manager 1908 and/or reception component 1902 depicted in FIG. 19) may receive one or more single UCIs, each single UCI being multiplexed to include overlapping UCIs, as described above.

As further shown in FIG. 17, in some aspects, process 1700 may include transmitting or receiving a communication based at least in part on the one or more single UCIs (block 1730). For example, the network entity (e.g., using communication manager 1908 and/or transmission component 1904 depicted in FIG. 19) may transmit or receiving a communication based at least in part on the one or more single UCIs, as described above.

Process 1700 may include additional aspects, such as any single aspect or any combination of aspects described below and/or in connection with one or more other processes described elsewhere herein.

In a first aspect, the configuration specifies jointly multiplexing the overlapping UCIs without differentiating TRPs, and the single UCI is jointly multiplexed without TRP differentiation.

In a second aspect, alone or in combination with the first aspect, the configuration specifies multiplexing the overlapping UCIs per TRP, and each single UCI of the one or more single UCIs is multiplexed for one TRP of the multiple TRPs.

In a third aspect, alone or in combination with one or more of the first and second aspects, resources for a PUSCH communication are punctured for the one or more single UCIs.

In a fourth aspect, alone or in combination with one or more of the first through third aspects, the overlapping UCIs include one or more of feedback, a scheduling request, or a CSI report.

In a fifth aspect, alone or in combination with one or more of the first through fourth aspects, the one or more single UCIs are in resources associated with a specified CORESET pool index.

In a sixth aspect, alone or in combination with one or more of the first through fifth aspects, a single UCI of the one or more single UCIs includes one or more UCIs that are jointly multiplexed from one or more UCIs on a PUCCH and one or more UCIs on a PUSCH.

In a seventh aspect, alone or in combination with one or more of the first through sixth aspects, a single UCI of the one or more single UCIs includes one or more UCIs that are jointly multiplexed from one or more UCIs in one or more first PUCCH communications and one or more UCIs in one or more second PUCCH communications.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram of an example apparatus 1800 for wireless communication. The apparatus 1800 may be a UE (e.g., a UE 120, UE 1020), or a UE may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a base station, or another wireless communication device) using the reception component 1802 and the transmission component 1804. As further shown, the apparatus 1800 may include the communication manager 1808. The communication manager 1808 may control and/or otherwise manage one or more operations of the reception component 1802 and/or the transmission component 1804. In some aspects, the communication manager 1808 may include one or more antennas, a modem, a controller/processor, a memory, or a combination thereof, of the UE described in connection with FIG. 2. The communication manager 1808 may be, or be similar to, the communication manager 140 depicted in FIGS. 1 and 2. For example, in some aspects, the communication manager 1808 may be configured to perform one or more of the functions described as being performed by the communication manager 140. In some aspects, the communication manager 1808 may include the reception component 1802 and/or the transmission component 1804. The communication manager 1808 may include one or more of a generation component 1810 and/or a selection component 1812, among other examples.

In some aspects, the apparatus 1800 may be configured to perform one or more operations described herein in connection with FIGS. 1-14. Additionally, or alternatively, the apparatus 1800 may be configured to perform one or more processes described herein, such as process 1500 of FIG. 15, process 1600 of FIG. 16, or a combination thereof. In some aspects, the apparatus 1800 and/or one or more components shown in FIG. 18 may include one or more components of the UE described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the UE described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the UE described in connection with FIG. 2. In some aspects, the transmission component 1804 may be co-located with the reception component 1802 in a transceiver.

In some aspects, the reception component 1802 may receive a configuration that specifies that overlapping UCIs on one or more physical uplink channels are to be jointly multiplexed into a single UCI for multiple TRPs. The generation component 1810 may generate the single UCI based at least in part on the configuration by jointly multiplexing the overlapping UCIs into the single UCI without differentiating TRPs. The transmission component 1804 may transmit the single UCI in an uplink communication.

The generation component 1810 may puncture resources for a PUSCH communication for the single UCI. The selection component 1812 may select resources for physical uplink channel communications of one TRP of the multiple TRPs to be resources for the single UCI.

In some aspects, the reception component 1802 may receive a configuration that specifies that overlapping UCIs on one or more physical uplink channels for multiple TRPs are to be multiplexed into a single UCI per TRP. The generation component 1810 may generate, for each TRP based at least in part on the configuration, the single UCI by multiplexing the overlapping UCIs for the TRP into the single UCI. The transmission component 1804 may transmit the single UCI in an uplink transmission for each TRP.

The generation component 1810 may puncture resources for a PUSCH communication for the single UCI for each TRP. The generation component 1810 may determine that the one or more UCIs on the PUCCH and the one or more UCIs on the PUSCH share a same TRP based at least in part on a rule. The generation component 1810 may determine that the one or more UCIs in the one or more first PUCCH communications and the one or more UCIs in the one or more second PUCCH communications share a same TRP based at least in part on a rule.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

FIG. 19 is a diagram of an example apparatus 1900 for wireless communication. The apparatus 1900 may be a network entity (e.g., base station 110, network entity 1010), or a network entity may include the apparatus 1900. In some aspects, the apparatus 1900 includes a reception component 1902 and a transmission component 1904, which may be in communication with one another (for example, via one or more buses and/or one or more other components). As shown, the apparatus 1900 may communicate with another apparatus 1906 (such as a UE, a base station, or another wireless communication device) using the reception component 1902 and the transmission component 1904. As further shown, the apparatus 1900 may include the communication manager 1908. The communication manager 1908 may control and/or otherwise manage one or more operations of the reception component 1902 and/or the transmission component 1904. In some aspects, the communication manager 1908 may include one or more antennas, a modem, a controller/processor, a memory, or a combination thereof, of the network entity described in connection with FIG. 2. The communication manager 1908 may be, or be similar to, the communication manager 150 depicted in FIGS. 1 and 2. For example, in some aspects, the communication manager 1908 may be configured to perform one or more of the functions described as being performed by the communication manager 150. In some aspects, the communication manager 1908 may include the reception component 1902 and/or the transmission component 1904. The communication manager 1908 may include a configuration component 1910, among other examples.

In some aspects, the apparatus 1900 may be configured to perform one or more operations described herein in connection with FIGS. 1-14. Additionally, or alternatively, the apparatus 1900 may be configured to perform one or more processes described herein, such as process 1700 of FIG. 17. In some aspects, the apparatus 1900 and/or one or more components shown in FIG. 19 may include one or more components of the network entity described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1902 may receive communications, such as reference signals, control information, data communications, or a combination thereof, from the apparatus 1906. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, a modem, a demodulator, a MIMO detector, a receive processor, a controller/processor, a memory, or a combination thereof, of the network entity described in connection with FIG. 2.

The transmission component 1904 may transmit communications, such as reference signals, control information, data communications, or a combination thereof, to the apparatus 1906. In some aspects, one or more other components of the apparatus 1900 may generate communications and may provide the generated communications to the transmission component 1904 for transmission to the apparatus 1906. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1906. In some aspects, the transmission component 1904 may include one or more antennas, a modem, a modulator, a transmit MIMO processor, a transmit processor, a controller/processor, a memory, or a combination thereof, of the network entity described in connection with FIG. 2. In some aspects, the transmission component 1904 may be co-located with the reception component 1902 in a transceiver.

The transmission component 1904 may transmit a configuration that specifies that overlapping UCIs on one or more physical uplink channels are to be jointly multiplexed into a single UCI for multiple TRPs. The configuration component 1910 may generate the configuration based at least in part on a UE capability, channel conditions, and/or traffic conditions. The reception component 1902 may receive one or more single UCIs, each single UCI being multiplexed to include overlapping UCIs. The transmission component 1904 may transmit or receiving a communication based at least in part on the one or more single UCIs.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

The following provides an overview of some Aspects of the present disclosure:

Aspect 1: A method of wireless communication performed by a user equipment (UE), comprising: receiving a configuration that specifies that overlapping uplink control informations (UCIs) on one or more physical uplink channels are to be jointly multiplexed into a single UCI for multiple transmit receive points (TRPs); generating the single UCI based at least in part on the configuration by jointly multiplexing the overlapping UCIs into the single UCI without differentiating TRPs; and transmitting the single UCI in an uplink communication.

Aspect 2: The method of Aspect 1, wherein generating the single UCI includes selecting resources for a physical uplink channel communication on the one or more physical uplink channels to be resources for the single UCI.

Aspect 3: The method of Aspect 1 or 2, further comprising puncturing resources for a physical uplink shared channel (PUSCH) communication for the single UCI.

Aspect 4: The method of any of Aspects 1-3, wherein the overlapping UCIs include one or more of feedback, a scheduling request, or a channel state information (CSI) report associated with the multiple TRPs.

Aspect 5: The method of any of Aspects 1-4, further comprising selecting resources for physical uplink channel communications of one TRP of the multiple TRPs to be resources for the single UCI.

Aspect 6: The method of Aspect 5, wherein the physical uplink channel communications are in a same serving cell and have a same starting symbol.

Aspect 7: The method of any of Aspects 1-6, wherein generating the single UCI includes selecting resources for a physical uplink channel of the one or more physical uplink channels to be resources associated with a specified control resource set pool index.

Aspect 8: The method of any of Aspects 1-7, wherein jointly multiplexing the overlapping UCIs includes jointly multiplexing one or more UCIs on a physical uplink control channel (PUCCH) and one or more UCIs on a physical uplink shared channel (PUSCH) into the single UCI.

Aspect 9: The method of any of Aspects 1-8, wherein jointly multiplexing the overlapping UCIs includes jointly multiplexing one or more UCIs in one or more first physical uplink control channel (PUCCH) communications and one or more UCIs in one or more second PUCCH communications into the single UCI.

Aspect 10: A method of wireless communication performed by a user equipment (UE), comprising: receiving a configuration that specifies that overlapping uplink control informations (UCIs) on one or more physical uplink channels for multiple transmit receive points (TRPs) are to be multiplexed into a single UCI per TRP; generating, for each TRP based at least in part on the configuration, the single UCI by multiplexing the overlapping UCIs for the TRP into the single UCI; and transmitting the single UCI in an uplink transmission for each TRP.

Aspect 11: The method of Aspect 10, wherein generating the single UCI for a TRP includes selecting resources for a physical uplink channel communication on the one or more physical uplink channels associated with the TRP to be resources for the single UCI for the TRP.

Aspect 12: The method of Aspect 10 or 11, further comprising puncturing resources for a physical uplink shared channel (PUSCH) communication for the single UCI for each TRP.

Aspect 13: The method of any of Aspects 10-12, wherein the multiplexing includes jointly multiplexing periodic CSI reports or semi-persistent CSI reports in physical uplink control channel (PUCCH) communications associated with different TRPs into a physical uplink channel communication associated with a specified control resource set pool index.

Aspect 14: The method of any of Aspects 10-13, wherein the multiplexing includes multiplexing channel state information (CSI) reports in one or more physical uplink channel communications per TRP.

Aspect 15: The method of any of Aspects 10-14, wherein the multiplexing includes multiplexing feedback or scheduling requests in one or more physical uplink channel communications per TRP.

Aspect 16: The method of any of Aspects 10-15, wherein the multiplexing includes multiplexing one or more UCIs on a physical uplink control channel (PUCCH) and one or more UCIs on a physical uplink shared channel (PUSCH) into the single UCI per TRP.

Aspect 17: The method of Aspect 16, further comprising determining that the one or more UCIs on the PUCCH and the one or more UCIs on the PUSCH share a same TRP based at least in part on a rule.

Aspect 18: The method of Aspect 17, wherein the rule is based at least in part on a shared transmission configuration indicator (TCI) state.

Aspect 19: The method of any of Aspects 10-18, wherein the multiplexing includes multiplexing one or more UCIs in one or more first physical uplink control channel (PUCCH) communications and one or more UCIs in one or more second PUCCH communications into the single UCI per TRP.

Aspect 20: The method of Aspect 19, further comprising determining that the one or more UCIs in the one or more first PUCCH communications and the one or more UCIs in the one or more second PUCCH communications share a same TRP based at least in part on a rule.

Aspect 21: A method of wireless communication performed by a network entity, comprising: transmitting a configuration that specifies that overlapping uplink control informations (UCIs) on one or more physical uplink channels are to be jointly multiplexed into a single UCI for multiple transmit receive points (TRPs); receiving one or more single UCIs, each single UCI being multiplexed to include overlapping UCIs; and transmitting or receiving a communication based at least in part on the one or more single UCIs.

Aspect 22: The method of Aspect 21, wherein the configuration specifies jointly multiplexing the overlapping UCIs without differentiating TRPs, and wherein the single UCI is jointly multiplexed without TRP differentiation.

Aspect 23: The method of Aspect 21, wherein the configuration specifies multiplexing the overlapping UCIs per TRP, and wherein each single UCI of the one or more single UCIs is multiplexed for one TRP of the multiple TRPs.

Aspect 24: The method of any of Aspects 21-23, wherein resources for a physical uplink shared channel (PUSCH) communication are punctured for the one or more single UCIs.

Aspect 25: The method of any of Aspects 21-24, wherein the overlapping UCIs include one or more of feedback, a scheduling request, or a channel state information (CSI) report.

Aspect 26: The method of any of Aspects 21-25, wherein the one or more single UCIs are in resources associated with a specified control resource set pool index.

Aspect 27: The method of any of Aspects 21-26, wherein a single UCI of the one or more single UCIs includes one or more UCIs that are jointly multiplexed from one or more UCIs on a physical uplink control channel (PUCCH) and one or more UCIs on a physical uplink shared channel (PUSCH).

Aspect 28: The method of any of Aspects 21-27, wherein a single UCI of the one or more single UCIs includes one or more UCIs that are jointly multiplexed from one or more UCIs in one or more first physical uplink control channel (PUCCH) communications and one or more UCIs in one or more second PUCCH communications.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving a configuration that specifies that overlapping uplink control informations (UCIs) on one or more physical uplink channels are to be jointly multiplexed into a single UCI for multiple transmit receive points (TRPs);
generating the single UCI based at least in part on the configuration by jointly multiplexing the overlapping UCIs into the single UCI without differentiating TRPs; and
transmitting the single UCI in an uplink communication.

2. The method of claim 1, wherein generating the single UCI includes selecting resources for a physical uplink channel communication on the one or more physical uplink channels to be resources for the single UCI.

3-6. (canceled)

7. The method of claim 1, wherein generating the single UCI includes selecting resources for a physical uplink channel of the one or more physical uplink channels to be resources associated with a specified control resource set pool index.

8-28. (canceled)

29. A user equipment (UE) for wireless communication, comprising:
a memory; and
one or more processors, coupled to the memory, configured to:
receive a configuration that specifies that overlapping uplink control informations (UCIs) on one or more physical uplink channels are to be jointly multiplexed into a single UCI for multiple transmit receive points (TRPs);
generate the single UCI based at least in part on the configuration by jointly multiplexing the overlapping UCIs into the single UCI without differentiating TRPs; and
transmit the single UCI in an uplink communication.

30. The UE of claim 29, wherein the one or more processors, to generate the single UCI, are configured to select resources for a physical uplink channel communication on the one or more physical uplink channels to be resources for the single UCI.

31. The UE of claim 29, wherein the one or more processors are configured to puncture resources for a physical uplink shared channel (PUSCH) communication for the single UCI.

32. The UE of claim 29, wherein the overlapping UCIs include one or more of feedback, a scheduling request, or a channel state information (CSI) report associated with the multiple TRPs.

33. The UE of claim 29, wherein the one or more processors are configured to select resources for physical uplink channel communications of one TRP of the multiple TRPs to be resources for the single UCI.

34. The UE of claim 33, wherein the physical uplink channel communications are in a same serving cell and have a same starting symbol.

35. The UE of claim 29, wherein the one or more processors, to generate the single UCI, are configured to select resources for a physical uplink channel of the one or more physical uplink channels to be resources associated with a specified control resource set pool index.

36. The UE of claim 29, wherein the one or more processors, to jointly multiplex the overlapping UCIs, are configured to jointly multiplex one or more UCIs on a physical uplink control channel (PUCCH) and one or more UCIs on a physical uplink shared channel (PUSCH) into the single UCI.

37. The UE of claim 29, wherein the one or more processors, to jointly multiplex the overlapping UCIs, are configured to jointly multiplex one or more UCIs in one or more first physical uplink control channel (PUCCH) communications and one or more UCIs in one or more second PUCCH communications into the single UCI.

38. A user equipment (UE) for wireless communication, comprising:
a memory; and
one or more processors, coupled to the memory, configured to:
receive a configuration that specifies that overlapping uplink control informations (UCIs) on one or more physical uplink channels for multiple transmit receive points (TRPs) are to be multiplexed into a single UCI per TRP;
generate, for each TRP based at least in part on the configuration, the single UCI by multiplexing the overlapping UCIs for the TRP into the single UCI; and
transmit the single UCI in an uplink transmission for each TRP.

39. The UE of claim 38, wherein the one or more processors, to generate the single UCI for a TRP, are configured to select resources for a physical uplink channel communication on the one or more physical uplink channels associated with the TRP to be resources for the single UCI for the TRP.

40. The UE of claim 38, wherein the one or more processors are configured to puncture resources for a physical uplink shared channel (PUSCH) communication for the single UCI for each TRP.

41. The UE of claim 38, wherein the multiplexing includes jointly multiplexing periodic CSI reports or semi-persistent CSI reports in physical uplink control channel (PUCCH) communications associated with different TRPs into a physical uplink channel communication associated with a specified control resource set pool index.

42. The UE of claim 38, wherein the multiplexing includes multiplexing channel state information (CSI) reports in one or more physical uplink channel communications per TRP.

43. The UE of claim 38, wherein the multiplexing includes multiplexing feedback or scheduling requests in one or more physical uplink channel communications per TRP.

44. The UE of claim 38, wherein the multiplexing includes multiplexing one or more UCIs on a physical uplink control channel (PUCCH) and one or more UCIs on a physical uplink shared channel (PUSCH) into the single UCI per TRP.

45. The UE of claim 44, wherein the one or more processors are configured to determine that the one or more UCIs on the PUCCH and the one or more UCIs on the PUSCH share a same TRP based at least in part on a rule.

46. The UE of claim 45, wherein the rule is based at least in part on a shared transmission configuration indicator (TCI) state.

47. The UE of claim 38, wherein the multiplexing includes multiplexing one or more UCIs in one or more first physical uplink control channel (PUCCH) communications and one or more UCIs in one or more second PUCCH communications into the single UCI per TRP.

48. The UE of claim 47, wherein the one or more processors are configured to determine that the one or more UCIs in the one or more first PUCCH communications and the one or more UCIs in the one or more second PUCCH communications share a same TRP based at least in part on a rule.

49. A network entity for wireless communication, comprising:
a memory; and
one or more processors, coupled to the memory, configured to:
transmit a configuration that specifies that overlapping uplink control informations (UCIs) on one or more physical uplink channels are to be jointly multiplexed into a single UCI for multiple transmit receive points (TRPs);
receive one or more single UCIs, each single UCI being multiplexed to include overlapping UCIs; and
transmit or receive a communication based at least in part on the one or more single UCIs.

50. The network entity of claim 49, wherein the configuration specifies jointly multiplexing the overlapping UCIs without differentiating TRPs, and wherein the single UCI is jointly multiplexed without TRP differentiation.

51. The network entity of claim 49, wherein the configuration specifies multiplexing the overlapping UCIs per TRP, and wherein each single UCI of the one or more single UCIs is multiplexed for one TRP of the multiple TRPs.

52. (canceled)

53. The network entity of claim 49, wherein the overlapping UCIs include one or more of feedback, a scheduling request, or a channel state information (CSI) report.

54. The network entity of claim 49, wherein the one or more single UCIs are in resources associated with a specified control resource set pool index.

55. The network entity of claim 49, wherein a single UCI of the one or more single UCIs includes one or more UCIs that are jointly multiplexed from one or more UCIs on a physical uplink control channel (PUCCH) and one or more UCIs on a physical uplink shared channel (PUSCH).

56. The network entity of claim 49, wherein a single UCI of the one or more single UCIs includes one or more UCIs that are jointly multiplexed from one or more UCIs in one or more first physical uplink control channel (PUCCH) communications and one or more UCIs in one or more second PUCCH communications.

57-62. (canceled)
